(19) United States
(12) Patent Application Publication
(10) Pub. No.: US 2019/0046385 A1
(43) Pub. Date: Feb. 14, 2019

(54) MASSAGE APPARATUS FOR MASSAGE CHAIR AND HAVING MASSAGE DEVICE

(71) Applicant: LURACO TECHNOLOGIES, INC., Arlington, VA (US)

(72) Inventors: KEVIN LE, RICHLAND HILLS, TX (US); THANH LE, GRAND PRAIRIE, TX (US); VARAD NITIN GOKHALE, IRVING, TX (US)

(21) Appl. No.: 15/675,700

(22) Filed: Aug. 11, 2017

(51) Int. Cl. A61H 1/00

(52) U.S. Cl. CPC A61H 1/006; A61H 2201/0149; A61H 2201/1604; A61H 2205/106; A61H 2201/1623; A61H 2205/108; A61H 2201/1609

(57) ABSTRACT

The present invention is directed to a massage apparatus for a massage chair wherein at least one massage device allows a user to adjust the intensity and position of a massage. The massage apparatus includes a frame and at least one massage device, and may also include a collision-sensing system or device. At least one massage element of at least one massage device is able to move in three-dimensional (3-D) directions. The massage element can be set to any position within the limits of the massage apparatus. When the massage apparatus includes more than one massage device and each massage device has more than one massage element, it is preferred that each massage element of at least one massage device is able to move in 3-D directions, and also preferred that the massage devices are able to travel or be moved along a track at or about the same time.

### BACKGROUND OF THE INVENTION

### Field of the Invention

The present invention generally relates to massage chairs and massage devices and apparatuses for massage chairs. More specifically, the present invention is directed to a massage apparatus for a massage chair wherein a massage mechanism or at least one massage device allows a user to adjust the intensity and position of a massage.

### Description of the Related Art

Massage chairs and massage devices, apparatuses and systems for massage chairs are known in the art. Different users have different preferences for massage type, intensity and/or hardness.

The present invention overcomes one or more of the shortcomings of massage chairs and massage devices, apparatuses and systems for massage chairs by providing an apparatus, and also possibly a method, for massage elements to move in three-dimensional (3-D) directions. The Applicants are unaware of inventions or patents, taken either singly or in combination, which are seen to describe the present invention as claimed.

### SUMMARY OF THE INVENTION

The present invention is directed to a massage apparatus for a massage chair wherein a massage mechanism or at least one massage device allows a user to adjust the intensity and position of a massage.

The massage apparatus includes a frame and at least one massage device. In addition, the massage apparatus may also include a collision-sensing system or device.

The present invention provides an apparatus, and also possibly a method, wherein at least one massage element of at least one massage device is able to move in three-dimensional (3-D) directions. The massage element can be set to any position within the limits of the massage apparatus. When the massage apparatus includes more than one massage device and each massage device has more than one massage element, it is preferred that each massage element of at least one massage device is able to move in 3-D directions, and also preferred that the massage devices are able to travel or be moved along a track at or about the same time. In addition, the collision-sensing system or device preferably includes or is in operational communication with collision control software to control the massage devices so as to prevent collisions between the massage devices.

As a non-limiting example, the massage apparatus includes a frame, a first massage device, and a second massage device. The massage apparatus further includes a collision-sensing system or device.

As a non-limiting example, the frame includes a pair of opposing guide rails, a plurality of guide rails stabilizing bars, and a base stand. The guide rails are secured to the base stand.

As a non-limiting example, the guide rails are substantially similar or mirror images of one another. Each of the guide rails includes a first end, a second end, a thigh body area portion located adjacent the first end, a seat or bottom body area portion located adjacent the thigh body area portion and away from the first end, a back body area portion extending upward from the bottom body area portion, a head and neck body area portion extending upward from the back body area portion and located about the second end, an outer side, an inner side, and a guide channel extending from the thigh body area portion to the back body area portion, preferably to the head and neck body area portion, and running along the inner side of the guide rail. The guide channel includes gear teeth for engaging with at least one gear member from each of the massage devices when each of the massage devices moves upward and downward in a generally vertical direction from the first end toward the second end of the guide rail and vice versa, respectively.

As a non-limiting example, the plurality of guide rails stabilizing bars help to stabilize the positioning of the guide rails relative to one another.

As a non-limiting example, with regard to the first massage device and second massage device, it is preferred that the massage devices are substantially or exactly the same as one another. It is also preferred that each massage element of each massage device is able to move in 3-D directions, and that the massage devices are able to travel or be moved along a track at or about the same time. As a non-limiting example, the first massage device and second massage device may be positioned, initially or when they are not in operation, about the first end and second end of the guide rails, respectively, and then they can move or be moved toward (or away from, when applicable) one another along the guide rails during operation. Thus, in combination with each other and via their massage elements, the first massage device and second massage device are preferably able to provide massage benefits or effects to more than one body area, such as a back body area, a bottom body area, a thigh body area, and a head and neck body area, of the user at or about the same time.

As a non-limiting example, each of the first massage device and second massage device generally includes at least one massage element (such as, but not limited to, a massage arm or member); at least one power source (such as, but not limited to, a power inlet, a battery or a motor) for powering or driving the massage device along the guide rails, for powering or driving the massage arm(s) or member(s) in an in-and-out motion, and for powering or driving the massage arm(s) or member(s) with regard to an intensity motion); a mechanism (such as, but not limited to, at least one massage arm rail) for allowing the massage element to produce the in-and-out motion; a mechanism for allowing the massage element to produce the intensity motion; and a mechanism (such as, but not limited to, at least one gear member) for operationally engaging with the guide rails.

### BRIEF DESCRIPTION OF THE DRAWINGS

FIG. 1 is a perspective view of a massage chair, wherein a massage apparatus for a massage chair according to the present invention is hidden under the exterior of the massage chair;

FIG. 2 is a perspective, front and right side view of a frame of a massage apparatus for a massage chair according to the present invention;

FIG. 3 is a perspective, front and left side view of another massage apparatus for a massage chair according to the present invention;

FIG. 4 is a left side view of the massage apparatus of FIG. 3;

FIG. 5 is a perspective, front and left side view of a massage device of the massage apparatus of FIG. 3;

FIG. 6 is a perspective, left side view of the massage device of FIG. 5;

FIG. 7 is an elevated, front view of the massage device of FIG. 5; and

FIG. 8 is an elevated, rear view of the massage device of FIG. 5.

It should be understood that the above-attached figures are not intended to limit the scope of the present invention in any way.

### DETAILED DESCRIPTION OF THE PREFERRED EMBODIMENTS

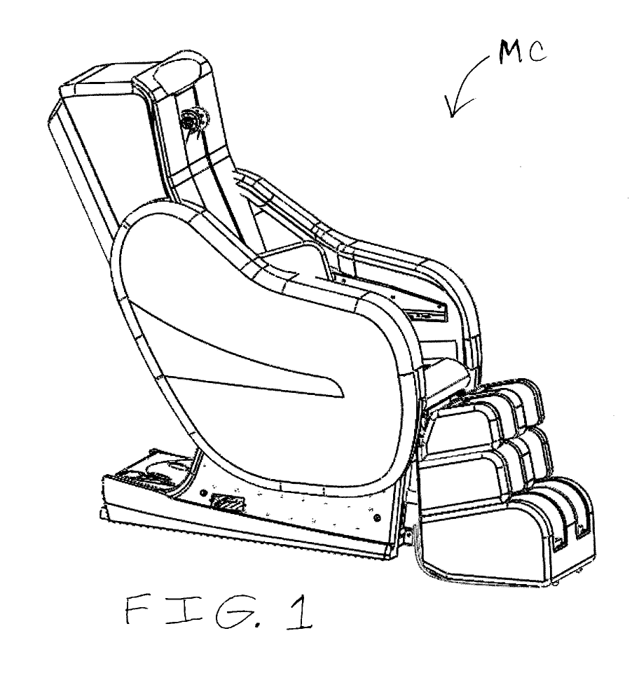

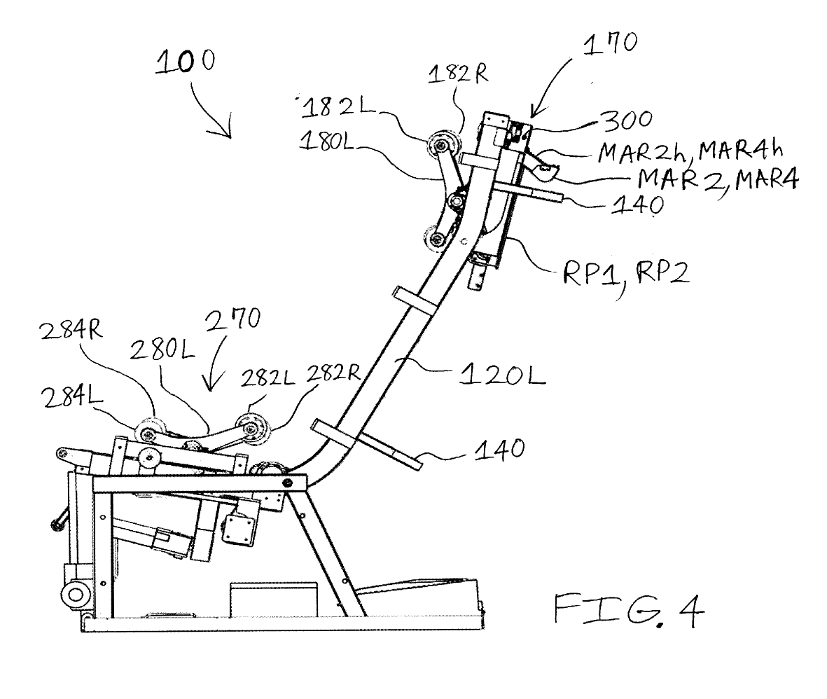

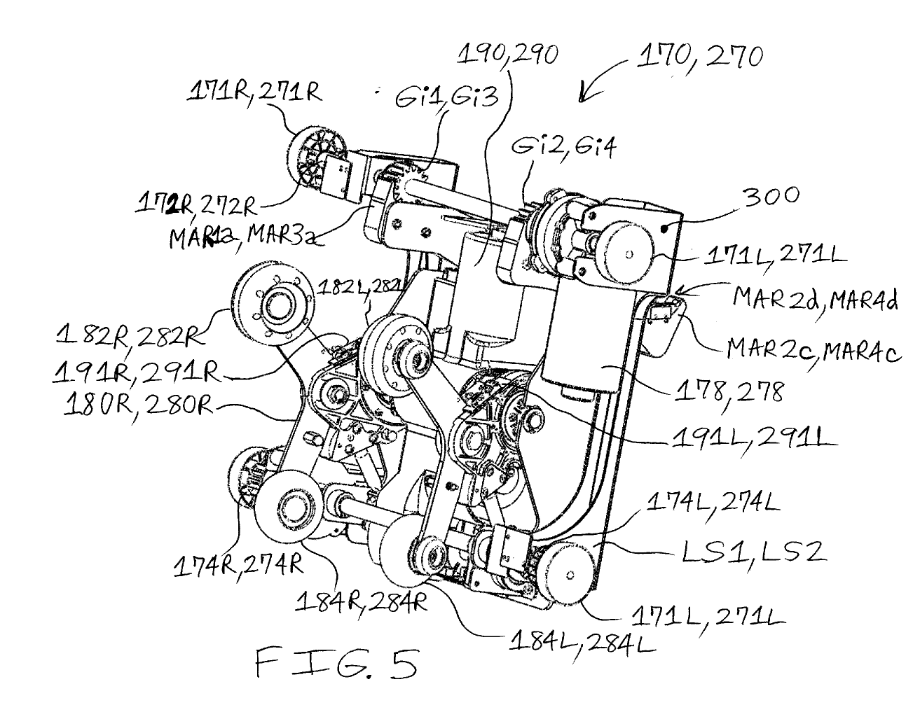

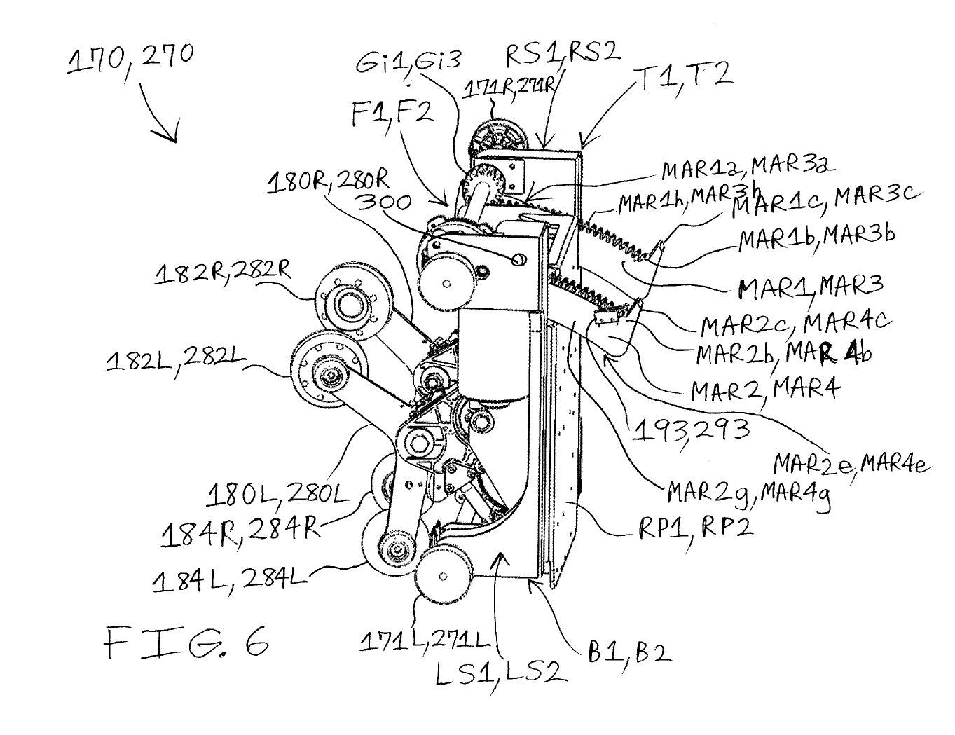

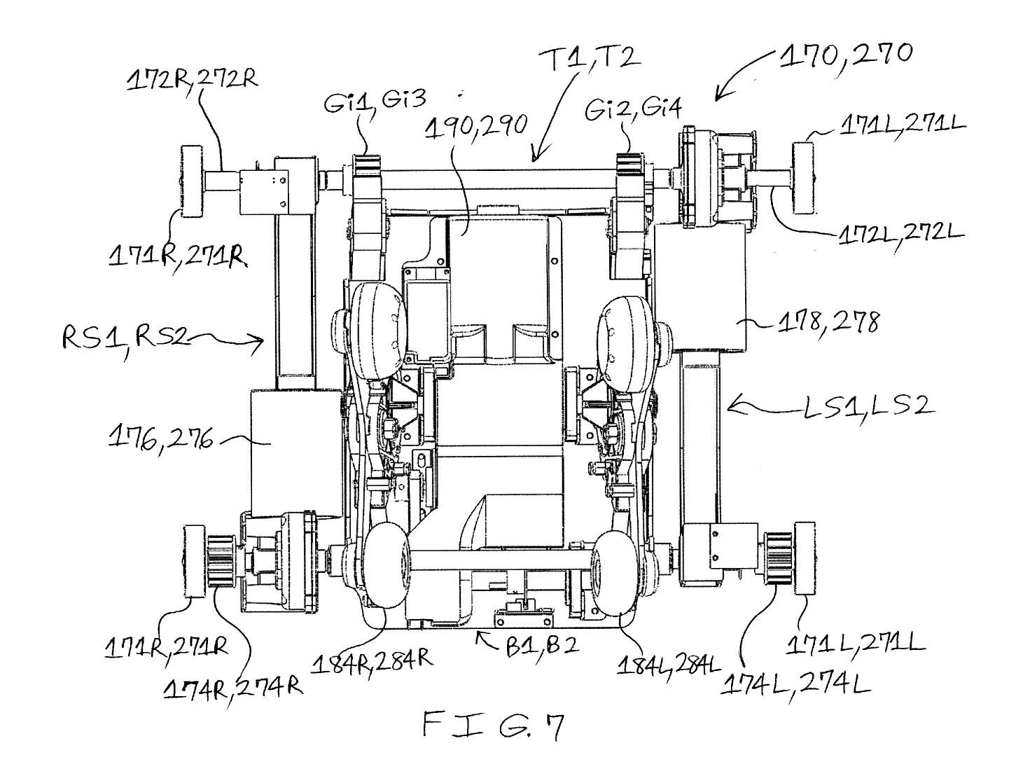

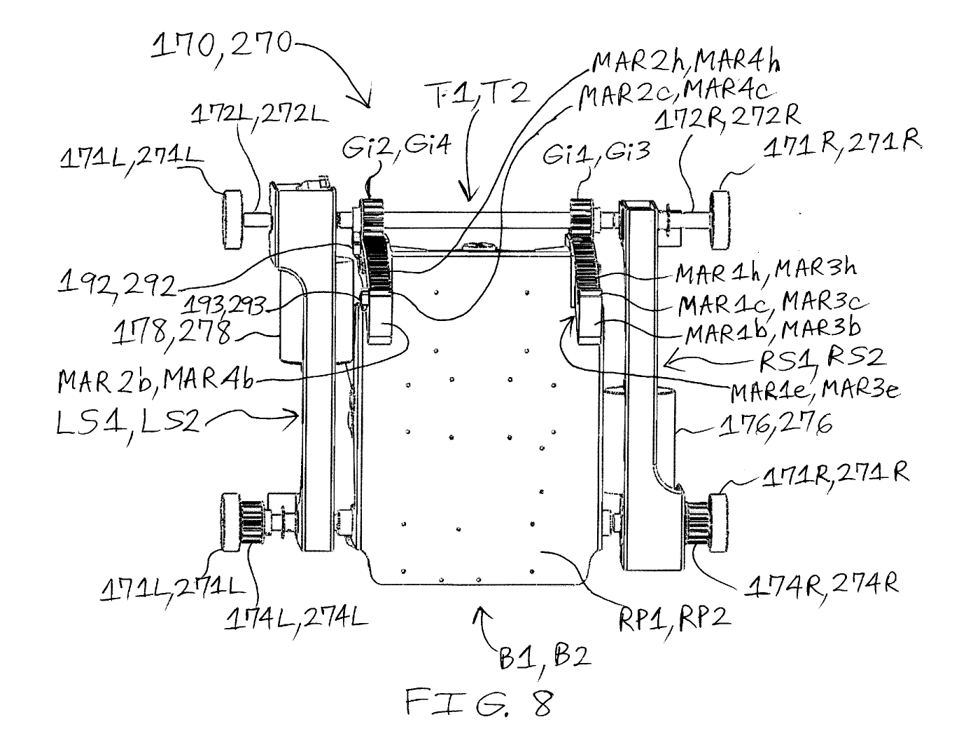

Referring to FIGS. 1-8, the present invention is directed to a massage apparatus 100 for a massage chair MC wherein a massage mechanism or at least one massage device 170,270 allows a user to adjust the intensity and position of a massage. The massage apparatus 100 comprises or includes a frame 110 and at least one massage device 170,270. In addition, the massage apparatus 100 may also comprise or include a collision-sensing system or device 300.

The present invention provides an apparatus 100, and also possibly a method, wherein at least one massage element (such as, but not limited to, massage arm or member 180R,180L,280R,280L) of at least one massage device 170,270 is able to move in three-dimensional (3-D) directions. The massage element 180R,180L,280R,280L can be set to any position within the limits of the massage apparatus 100. When the massage apparatus 100 includes more than one massage device 170,270 and each massage device 170,270 has more than one massage element 180R,180L,280R,280L, it is preferred that each massage element 180R,180L,280R,280L of at least one massage device 170,270 is able to move in 3-D directions, and also preferred that the massage devices 170,270 are able to travel or be moved along a track (such as, but not limited to, guide rail(s) 120R,120L) at or about the same time. In addition, the collision-sensing system or device 300 preferably includes or is in operational communication with collision control software to control the massage devices 170,270 so as to prevent collisions between the massage devices 170,270.

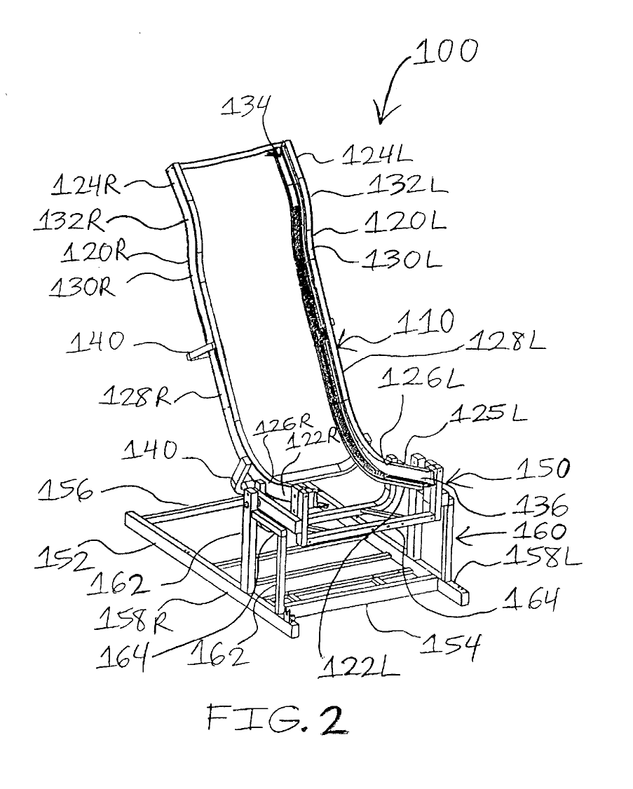

As a non-limiting example and as best shown in FIGS. 2-4, the massage apparatus 100 includes a frame 110, a first massage device 170, and a second massage device 270. The massage apparatus 100 further includes a collision-sensing system or device 300.

As best shown in FIGS. 2-4, the frame 110 of the massage apparatus 100 includes a pair of opposing guide rails 120R,120L, a plurality of guide rails stabilizing bars 140, and a base stand 150. The guide rails 120R,120L are secured to the base stand 150, and are positioned generally above the base stand 150. Preferably, the base stand 150 is manufactured and/or constructed of a material(s) that is able to support the weights of the guide rails 120R,120L, massage devices 170,270, and user (not shown) of the massage chair.

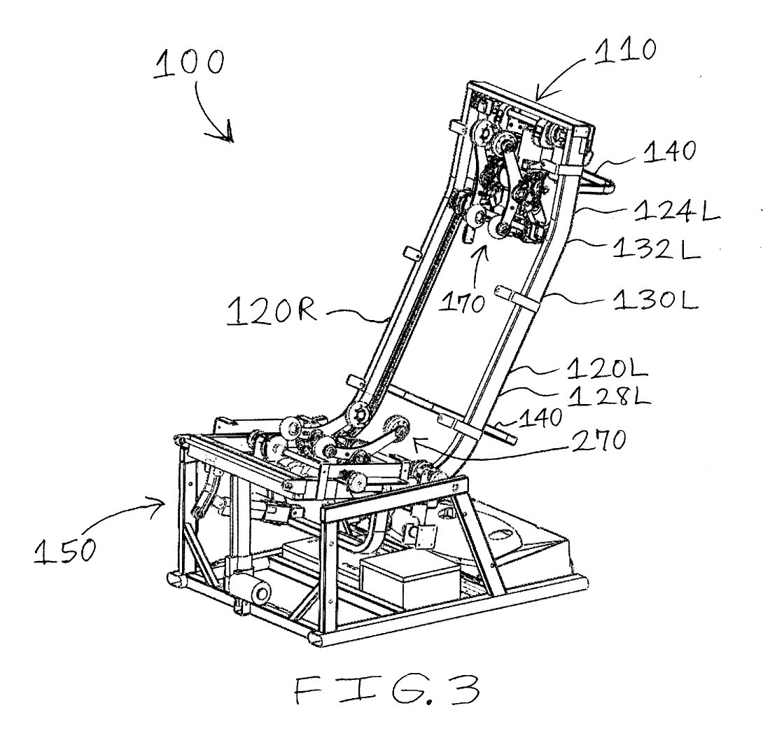

Preferably, the guide rails 120R,120L are substantially similar or mirror images of one another. Each of the guide rails 120R,120L includes a first end 122R,122L, a second end 124R,124L, a thigh body area portion 125R,125L located adjacent the first end 122R,122L, a seat or bottom body area portion 126R,126L located adjacent the thigh body area portion 125R,125L and away from the first end 122R,122L, a back body area portion 128R,128Lbb extending upward from the bottom body area portion 126R,126L, a head and neck body area portion 130R,130L extending upward from the back body area portion 128R,128L and located about the second end 124R,124L, an outer side 132R,132L, an inner side 134, and a guide channel 136 extending from the thigh body area portion 125R,125L to the back body area portion 128R,128L, preferably to the head and neck body area portion 130R,130L, and running along the inner side 134 of the guide rail 120R,120L. The guide channel 136 includes gear teeth 138 for engaging with at least one gear member from each of the massage devices 170,270 when each of the massage devices 170,270 moves upward and downward in a generally vertical direction from the first end 122R,122L toward the second end 124R,124L of the guide rail 120R,120L and vice versa, respectively. Preferably, each of the guide rails 120R,120L has a generally “L-shaped” configuration. In this configuration, the lower portion of the “L” includes the thigh body area portion 125R,125L and bottom body area portion 126R,126L, and the upper portion of the “L” includes the back body area portion 128R,128L and head and neck body area portion 130R,130L. As best shown in FIGS. 1 and 3, more preferably, each of the guide rails 120R,120L has a reclining “L-shaped” configuration.

The plurality of guide rails stabilizing bars 140 help to stabilize the positioning of the guide rails 120R,120L relative to one another. Each of the guide rails stabilizing bars 140 has a first end 142, a second end 144, and a body portion 146 extending from the first end 142 to the second end 144. Preferably, each of the guide rails stabilizing bars 140 has a generally “U-shaped” configuration. The guide rails stabilizing bars 140 are secured at predetermined locations along the outer sides 132R,132L of the guide rails 120R,120L.

The base stand 150 includes a base 152 and a guide rails support structure 160. The base 152 includes a first or front end 154, a second or rear end 156, and a pair of opposing sides 158R,158L. The guide rails support structure 160 is secured about the front end 154 of the base 152, and is positioned above the base 152. The guide rails support structure 160 includes a plurality of vertical bars or members 162 and a plurality of horizontal bars or members 164. The plurality of vertical bars 162 extend upward from the pair of opposing sides 158R,158L of the base 152, and, along with the plurality of horizontal bars 164, form a support frame with a “square-shaped” or “rectangular-shaped” box configuration.

Since the base stand 150 preferably supports the weights of the guide rails 120R,120L, massage devices 170,270, and user of the massage chair, the base stand 150 is preferably made or manufactured of a strong material, such as, but not limited to, steel, metal, wood, hard plastic, any combination of the listed materials, and any material or combination of materials known to one of ordinary skill in the art. Also, the guide rails 120R,120L may be made or manufactured of steel, metal, wood, plastic, any combination of the listed materials, and any material or combination of materials known to one of ordinary skill in the art.

With regard to the first massage device 170 and second massage device 270 (as best shown in FIGS. 3-8), it is preferred that the massage devices 170,270 are substantially or exactly the same as one another. It is also preferred that each massage element (such as, but not limited to, massage arm or member 180R,180L,280R,280L) of each massage device 170,270 is able to move in 3-D directions, and that the massage devices 170,270 are able to travel or be moved along the guide rail(s) 120R,120L at or about the same time. As a non-limiting example, the first massage device 170 and second massage device 270 may be positioned, initially or when they are not in operation, about the first end and second end of the guide rails 120R,120L, respectively, and then they can move or be moved toward (or away from, when applicable) one another along the guide rails 120R,120L during operation. Thus, in combination with each other and via their massage elements 180R,180L,280R,280L, the first massage device 170 and second massage device 270 are preferably able to provide massage benefits or effects to more than one body area, such as a back body area, a bottom body area, a thigh body area, and a head and neck body area, of the user at or about the same time.

Each of the first massage device 170 and second massage device 270 generally includes at least one massage element (such as, but not limited to, a massage arm or member 180R,180L,280R,280L); at least one power source (such as, but not limited to, a power inlet, a battery or a motor) for powering or driving the massage device 170,270 along the guide rails 120R,120L, for powering or driving the massage arm(s) or member(s) 180R,180L,280R,280L in an in-and-out motion, and for powering or driving the massage arm(s) or member(s) 180R,180L,280R,280L with regard to an intensity motion); a mechanism (such as, but not limited to, at least one massage arm rail MAR1,MAR2,MAR3,MAR4) for allowing the massage element 180R,180L,280R, 280L to produce the in-and-out motion; a mechanism for allowing the massage element 180R,180L,280R,280L to produce the intensity motion; and a mechanism (such as, but not limited to, at least one gear member) for operationally engaging with the guide rails 120R,120L.

As a non-limiting example and as best shown in FIGS. 3-8, each of the first and second massage devices 170,270 includes a front F1,F2, a rear plate RP1,RP2, a right side RS1,RS2, a left side LS1,L52, a top T1,T2, a bottom B1,B2, a pair of massage arm rails MAR1,MAR2,MAR3,MAR4, a pair of gear devices Gi1,Gi2,Gi3,Gi4 driven by a motor to control the intensity motion of the massage arms, four supporting wheels 171R,171L,271R,271L, a pair of massage device moving members 172R,172L,272R,272L, a pair of guide rail gear members 174R,174L,274R,274L, a pair of massage arms or members 180R,180L,280R,280L, a first motor 176,276, a second motor 178,278, a third motor 190,290, a pair of position sensing devices 191R,191L,291R,291L, and a pair of limit sensing devices 192,193,292,293.

Preferably, each massage arm rail of the corresponding pair of massage arm rails MAR1,MAR2,MAR3,MAR4 is substantially similar to or exactly the same as the other massage arm rail of that corresponding pair. More preferably, each massage arm rail of the massage arm rails MAR1,MAR2,MAR3,MAR4 is substantially similar to or exactly the same as one another. Each of the massage arm rails MAR1,MAR2,MAR3,MAR4 includes a first end MAR1a,MAR2a,MAR3a, MAR4a, a second end MAR1b,MAR2b,MAR3b,MAR4b with a stop member MAR1c,MAR2c,MAR3c,MAR4c, a top MAR1d,MAR2d,MAR3d,MAR4d, a bottom MAR1e,MAR2e,MAR3e,MAR4e, a first side MAR1f,MAR2f,MAR3f,MAR4f, a second side MAR1g,MAR2g,MAR3g,MAR4g, and gear teeth MAR1h,MAR2h, MAR3h,MAR4h located about the top MAR1d,MAR2d,MAR3d,MAR4d. The gear teeth MAR1h,MAR2h,MAR3h,MAR4h of the massage arm rails MAR1,MAR2, MAR3,MAR4 engage with corresponding gear devices Gi1,Gi2,Gi3,Gi4 from corresponding massage devices 170,270 to control the intensity motion of the massage arms 180R,180L,280R,280L.

Each of the four supporting wheels 171R,171L,271R,271L and of the massage device moving members 172R,172L,272R,272L is positioned within a corresponding guide channel 136 of a guide rail 120R,120L, and helps the massage devices 170,270 move in a generally vertical direction along the guide channel 136.

Each of the guide rail gear members 174R,174L,274R,274L is positioned within a corresponding guide channel 136 of a guide rail 120R,120L, and engages with the teeth 138 located in the corresponding guide channel 136.

Each of the massage arms 180R,180L,280R,280L includes a first or upper massage roller 182R,182L,282R,282L and a second or lower massage roller 184R,184L,284R,284L. Preferably, each of the massage arms 180R,180L, 280R,280L is able to move in 3-D directions. This means that each of the massage arms 180R,180L,280R,280L is able to move laterally (in an x-axis direction, or side to side direction of the body of a user), vertically (in a y-axis direction, or head to toe direction of the body of a user), and in-and-out (in a z-axis direction, or front to back direction of the body of a user). The massage rollers 182R,182L,282R,282L,184R,184L,284R,284L provide massage benefits or effects to a back body area, a bottom body area, and a thigh body area of the user when the massage devices 170,270 are moved to, near or about that particular body area. The massage rollers 182R,182L,282R,282L,184R,184L, 284R,284L may also provide massage benefits or effects to a head and neck area of the user when the massage devices 170,270 are moved to, near or about the head and neck area. It will be understood by one of ordinary skill in the art that the timing of the pattern of the movement, such as raising and lowering, of the rollers 182R,182L,282R,282L,184R,184L,284R,284L in any, some or all of the 3-D directions may be varied on each roller 182R,182L,282R,282L,184R, 184L,284R,284L. These rollers 182R,182L,282R,282L,184R,184L,284R,284L can move in 3-D directions by controlling the three motors: the first motor 176,276, the second motor 178,278, and the third motor 190,290.

Each first motor 176,276 is preferably positioned toward the front F1,F2 and on the right side RS1,RS2 of the corresponding massage device 170,270, and is in operational communication with the corresponding pair of the massage arms 180R,180L,280R,280L such that it causes or drives the up-and-down motion of the corresponding pair of the massage arms 180R,180L,280R, 280L. Also, the massage devices 170,270 travel or are moved along the guide rails 120R,120L via gears 174R,174L,274R,274L and first motor 176,276.

Each second motor 178,278 is preferably positioned toward the front F1,F2 and on the left side LS1,L52 of the corresponding massage device 170,270, and is in operational communication with the corresponding pair of the massage arms 180R,180L,280R,280L such that it causes or drives the intensity motion of the corresponding pair of massage arms 180R,180L,280R,280L.

Each third motor 190,290 is preferably positioned toward the front F1,F2 and top T1,T2 of the corresponding massage device 170,270, and is in operational communication with the corresponding pair of the massage arms 180R,180L,280R,280L such that it causes or drives the in-and-out motion of the corresponding pair of the massage arms 180R,180L,280R,280L.

Each pair of position sensing devices 191R,191L,291R,291L are preferably positioned about the corresponding upper massage rollers 182R,182L,282R,282L of the corresponding massage arms 180R,180L,280R, 280L, and are for detecting the user's body contour and shoulder position.

Each pair of limit sensing devices 192,193,292,293 are preferably positioned about the corresponding first end MAR1a,MAR2a,MAR3a,MAR4a and corresponding second end MAR1b,MAR2b,MAR3b,MAR4b of the corresponding massage arm rails MAR2,MAR4, and are for detecting the maximum to minimum position points as the massage arms 180R,180L,280R,280L move forward and rearward (or “in and out”) via the massage arm rails MAR1,MAR2,MAR3,MAR4 moving forward and rearward relative to the positions of the gear devices Gi1, Gi2,Gi3,Gi4 of the corresponding massage device 170,270.

The collision-sensing system or device 300 preferably is positioned on one or both of the massage devices 170,270, and preferably includes or is in operational communication with collision control software to control the massage devices 170,270 so as to prevent collisions between the massage devices 170,270. In addition, the collision-sensing system or device 300 preferably includes or is in operational communication with control software that prevents or stops the massage devices 170,270 from exiting or going out of the guide rails 120R,120L at the first and second ends 122R,122L,124R,124L of the guide rails 120R,120L.

When in use or in operation, the user (not shown) preferably activates both of the massage devices 170,270 of the massage apparatus 100 for a massage chair by or via pushing, touching, using voice command for use on or with, using a mechanical or remote control for use on or with, or any other activation method known to one of ordinary skill in the art, an activation, start, control or command button, touch area, box or panel, or any other activation method or element known to one of ordinary skill in the art. Preferably, the user is able to control the generally vertical movement of the massage devices 170,270 and massage rollers 182R,182L,184R,184L,282R,282L,284R,284L upward and downward along the guide rails 120R,120L such that the massage devices 170,270 and massage rollers 182R,182L,184R,184L,282R,282L, 284R,284L are positioned about, near or at a desired body part area, such as the thighs, bottom, lower back, upper back, and head and neck, of the user so that desired body part area of the user can receive massage effects or benefits from the massage rollers 182R,182L,184R,184L,282R,282L,284R,284L when desired and with the desired intensity and/or with the desired in-and-out motion. Preferably, the user is also able to control the timing, movement, etc. of the massage rollers 182R,182L,184R,184L,282R,282L,284R,284L such that that the massage rollers 182R,182L,184R,184L,282R,282L,284R,284L can provide massage effects or benefits to different desired body part areas of the user at or about the same time and with the desired intensity and/or with the desired in-and-out motion.

It is to be understood that the present invention is not limited to the embodiments described above or as shown in the attached figures, but encompasses any and all embodiments within the spirit of the invention.

What is claimed is:

1. A massage apparatus for a massage chair comprising:
a frame comprising a pair of guide rails,
wherein each of said guide rails comprises a first end, a second end, a thigh body area portion located about said first end, a bottom body area portion located proximate said thigh body area portion and away from said first end, and a back body area portion extending upward from said bottom body area portion; and
a massage system comprising a first massage device and a second massage device,
wherein said first massage device and said second massage device are operationally engaged with said guide rails such that said first massage device and said second massage device are able to travel along said guide rails during operation,
wherein each of said first massage device and said second massage device comprises at least one massage element, a guide rail engagement mechanism, at least one power source for powering said massage devices along said guide rails, and at least one power source for powering said at least one massage element in an in-and-out motion, and
wherein at least one of said at least one massage element is able to move in three-dimensional directions.

2. The massage apparatus for a massage chair according to claim 1, wherein said guide rails has a generally “L-shaped” configuration.

3. The massage apparatus for a massage chair according to claim 1, wherein each of said guide rails further comprises a head and neck body area portion extending upward from said back body area portion and located about said second end, an outer side, an inner side, and a guide channel extending from said thigh body area portion to said head and neck body area portion, and running along said inner side of said guide rails, and wherein each of said guide channels includes gear teeth for engaging with at least one gear member from each of said massage devices when each of said massage devices moves upward and downward in a generally vertical direction from said first end toward said second end of said guide rails and vice versa, respectively.
